(19) United States
(12) Patent Application Publication
(10) Pub. No.: US 2022/0198372 A1
(43) Pub. Date: Jun. 23, 2022

(54) TIME-SERIES MACHINE LEARNING MODEL-BASED RESOURCE DEMAND PREDICTION

(71) Applicant: Hewlett-Packard Development Company, L.P., Spring, TX (US)

(72) Inventors: Sandip Brahmachary, Pune (IN); Narendra Kumar Chincholikar, Pune (IN)

(73) Assignee: Hewlett-Packard Development Company, L.P., Spring, TX (US)

(21) Appl. No.: 17/418,796

(22) PCT Filed: Sep. 11, 2019
(86) PCT No.: PCT/US2019/050495

§ 371 Date: Jun. 26, 2021

(51) Int. Cl. G06Q 10/06; G06Q 10/10; G06F 40/20

(52) U.S. Cl. CPC G06Q 10/063118; G06Q 10/06313; G06N 20/00; G06F 40/20; G06Q 10/1053

(57) ABSTRACT

In one example, a non-transitory machine-readable storage medium encoded with instructions that, when executed by a processor, may cause the processor to obtain historical recruitment data associated with an enterprise for a period, pre-process the historical recruitment data, filter the pre-processed historical recruitment data based on a set of recruitment parameters, build a timeseries machine learning model with the filtered historical recruitment data associated with a portion of the period, test the time-series machine learning model with the filtered historical recruitment data associated with a remaining portion of the period, and predict a resource demand for an upcoming period using the timeseries machine learning model based on successful testing.

### BACKGROUND

Demand forecasting may be a utility to leverage industries (e.g., recruitment departments) to predict gaps in workforce in upcoming periods. Demand forecasting may be used in many different industries to facilitate planning for future demands. Forecasting may be a process of making predictions based on past data, present data, analysis of trends, and/or the like. For example, an organization can use a forecasting technique to predict a change to supply and/or demand, thereby enabling the organization to take one or more steps, such as hiring employees, to prepare for the change to supply and/or demand.

### BRIEF DESCRIPTION OF THE DRAWINGS

Examples are described in the following detailed description and in reference to the drawings, in which:

FIG. 1A is a block diagram of an example apparatus, including a resource demand prediction engine to predict a hiring demand using a time-series machine learning model;

FIG. 1B is a block diagram of the example apparatus of FIG. 1A, depicting additional features;

FIG. 2 is a schematic diagram of an example process for predicting a hiring demand;

FIG. 3 is a schematic diagram of an example process for generating a job description based on the predicted hiring demand and determining a suitable profile corresponding to the job description;

FIG. 4 is a block diagram of an example computing device including a non-transitory machine-readable storage medium, storing instructions to predict a hiring demand using a time-series machine learning model; and

FIG. 5 is a flow diagram illustrating an example method for retrieving a suitable profile along with a matching score corresponding to a gap in proficiency associated with a predicted hiring demand.

### DETAILED DESCRIPTION

Understanding the relative value of proficiencies to an enterprise may be desirable to success. Without a clear understanding of what the enterprise needs with respect to the current business of the enterprise and upcoming projects, it may be difficult for the enterprise to ensure the employees are qualified in the correct proficiencies. Most enterprises may rely upon human knowledge to inform hiring and training. For example, managers and human resources (HR) personnel know of specific projects and tasks that require staffing, but this misses the global picture of that is needed within the enterprise, risks created by employee movements, and lack of training in skills needed

Recruitment departments of enterprises may face issues in hiring due to paucity of advanced information about upcoming demands. Moreover, manual intervention and assumptions may produce biased and inaccurate prediction which can result into inappropriate demand forecasting. Additionally, the management may have to adjust cost and utilization of workforce on the fly. However, the entire demand fulfillment workflow may depend upon unplanned and ad-hoc approaches and decisions.

Examples described herein may provide obtaining historical recruitment data associated with an enterprise, dividing the pre-processed historical recruitment data associated with a set of recruitment parameters into a training dataset, a validation dataset, and a testing dataset, training a time-series machine learning model with the training dataset, validating the trained time-series machine learning model with the validation dataset, testing the time-series machine learning model with the testing dataset, predicting a resource demand for an upcoming period using the time-series machine learning model based on successful testing, and retrieving a suitable profile along with a matching score by accessing a job site based on the resource demand.

Examples described herein may facilitate machine learning process using time-series historical recruitment data in order to provide an automated advanced demand forecasting to fulfill the hiring demands of enterprises. Demand forecasting may leverage recruitment departments to predict a number of employees to be hired in an upcoming period. Demand prediction may further provide a tentative location-wise number based upon different technologies, roles, experiences, and the like. Further, the predicted resource demand may provide a tentative picture in advance to recruitment department and/or enterprises to provision in terms of the cost and resource to on-board or hire employees of different skills and experiences across the locations.

Further, example described herein may produce a close to actual resource demands to the recruitment and hiring authority in advance considering current back-fill and/or strategic requirements in different technologies, roles, and/or experiences. Enterprises can initiate planning in advance to meet the timeline which can help delivery teams to onboard suitable candidate(s) in time to deliver assignments timely. Thus, enterprises can have considerable time to do planning and budgeting to the concerned teams to onboard new employees in a smoother way.

In the following description, for purposes of explanation, numerous specific details are set forth in order to provide a thorough understanding of the present techniques. It will be apparent, however, to one skilled in the art that the present apparatus, devices and systems may be practiced without these specific details. Reference in the specification to “an example” or similar language means that a particular feature, structure, or characteristic described is included in at least that one example, but not necessarily in other examples.

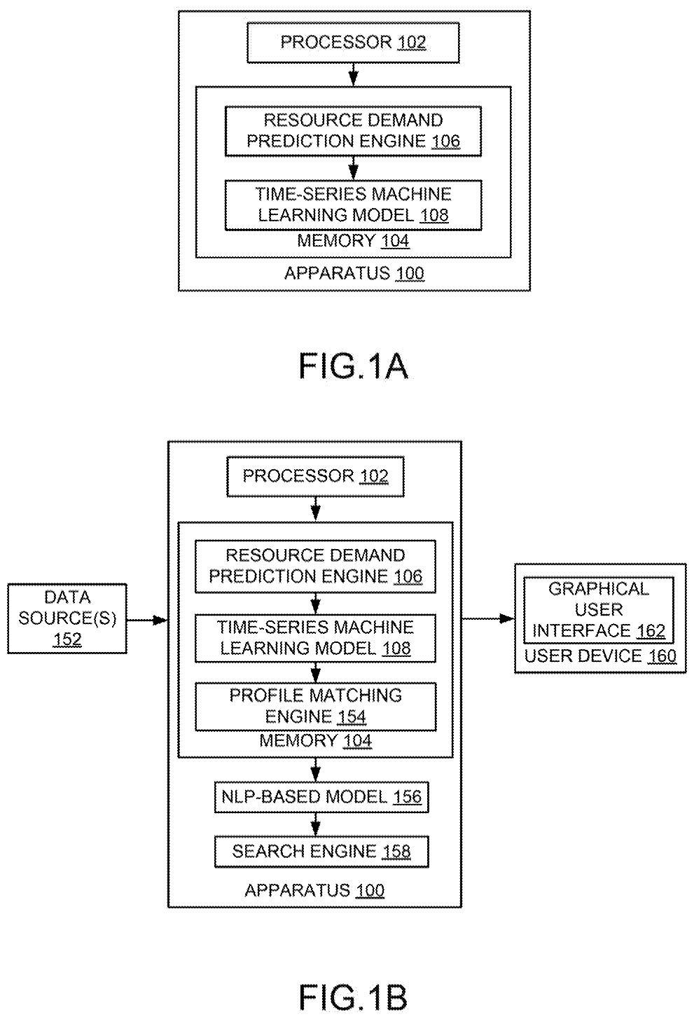

Turning now to the figures, FIG. 1A is a block diagram of an example apparatus 100, including a resource demand prediction engine 106 to predict a hiring demand using a time-series machine learning model 108. As used herein, the term “apparatus” may represent, but is not limited to, a personal computer (PC), a server, a notebook, a tablet, a smartphone, a personal digital assistant, or any general-purpose computing device.

Example apparatus 100 may include a processor 102 and a memory 104 coupled to processor 102. Memory, 104 may include resource demand prediction engine 106. In some examples, components of apparatus 100 may be implemented in hardware, machine-readable instructions, or a combination thereof. In one example, resource demand prediction engine 106 may be implemented as an engine or a module including any combination of hardware and programming to implement the functionalities described herein.

During operation, resource demand prediction, engine 106 may obtain histories recruitment data associated with an enterprise for a period. As used herein, “historical recruitment data” may be a sequence of data that is repeatedly generated and/or captured at a plurality of time values during a certain time interval. Further, resource demand prediction engine 106 may cleanse and impute the historical recruitment data. Furthermore, resource demand prediction engine 106 may divide the cleansed and imputed historical recruitment data associated with a set of recruitment parameters into a training dataset, a validation dataset, and a testing dataset.

Resource demand prediction engine 106 may build time-series machine learning model 108 with the training dataset and validate trained time-series machine learning model 108 with the validation dataset. For example, the validation dataset may be a sample of data held back from training/building timeseries machine learning model 108 that is used to give an estimate of model skill while tuning model's parameters. The validation dataset may be held back from the training of the model, but is instead used to give an unbiased estimate of the skill of the final tuned model when comparing or selecting between final models.

Further, resource demand prediction engine 106 may testtime-series machine learning model 108 with the testing dataset. In one example, resource demand prediction engine 106 may test time-series machine learning model 108 by predicting a resource demand for a period corresponding to test dataset using time-series machine learning model 108 and determining accuracy of time-series machine learning model 108 by comparing the predicted resource demand for the period with the test dataset. In this example, time-series machine learning model 108 can be used to predict the resource demand for an upcoming period when the accuracy is greater than or equal to a predefined threshold.

Further, resource demand prediction engine 106 may predict a resource demand for the upcoming period using time-series machine learning model 108 based on successful testing (i.e., when the accuracy is greater than or equal to the predefined threshold). In this example, time-series machine learning model 108 may utilize latest available time-series recruitment data associated with the enterprise to predict the resource demand for the upcoming period. For example, resource demand prediction engine 106 may manage financial and/or infrastructure resources for a number of employees to be hired for the upcoming period (e.g., next 3 months) corresponding to the predicted resource demand. Resource demand prediction engine 106 may transmit the predicted resource demand as recommendation to a user device for display.

In one example, resource demand prediction engine 106 may predict the resource demand for the upcoming period based on at least one of replacement and strategic constraints in proficiency constraint. The proficiency constraint may be selected from a group consisting of different technology areas, roles, and experiences. For example, resource demand prediction engine 106 may predict a gap in the proficiency constraint and determine a recommendation to remedy the gap. Further, resource demand prediction engine 106 may transmit the recommendation to a user device for display.

Thus, an automated forecasting of hiring demand can be evaluated for forthcoming months or quarters considering the strategic requirements (e.g., new hiring) and replacement requirements using time-series machine learning model 108. Utilizing time-series machine learning model 108 may overcome human mistakes and incorrect assumptions associated with the hiring demand prediction. Further, time-series machine learning model 108 may enable to effectively provision cost and/or infrastructure resources for near to accurate hiring count.

Further, the output of time-series machine learning model 108 may be stored in a database for future analysis. Also, the output of time-series machine learning model 108 can be provided to various tools associated with hiring and provisioning new hires as shown in FIG. 1B.

FIG. 1B is a block diagram of example apparatus 100 of FIG. 1A, depicting additional features. For example, similarly named elements of FIG. 1B may be similar in structure and/or function to elements described with respect to FIG. 1A. As shown in FIG. 1B, apparatus 100 may obtain the historical recruitment data from various data sources 152 via a corresponding network interface. For example, data sources 152 may include data regarding attrition, location change, retirement, skill upgrade, strategic investment, intern to hire conversion, contractor to hire conversion, technology area, experience, upcoming projects, various departments, and any other employment/project related information.

Memory 104 may further include a profile matching engine 154 to input the resource demand for the upcoming period into a natural language processing (NLP)-based model 156, which may generate a job description corresponding to a gap in proficiencies of an employed workforce using a job description database and the resource demand, and generate a search string using the job description. Also, profile matching engine 154 may input the search string to a search engine 158 to determine a suitable profile along with a matching score corresponding to the job description by accessing a job site. Further, profile matching engine 154 may transmit the suitable profile along with the matching score to a user device 160. In one example, the suitable profile may be displayed on a graphical user interface 162 of user device 160. In another example, the suitable profile may be displayed on a display of apparatus 100.

In some examples, components of apparatus 100 may be implemented in hardware, machine-readable instructions, or a combination thereof. In one example, resource demand prediction engine 106 and profile matching engine 154 may be implemented as an engine or a module including any combination of hardware and programming to implement the functionalities described herein.

Apparatus 100 may include computer-readable storage medium having (e.g., encoded with) instructions executable by a processor to implement respective functionalities described herein in relation to FIGS. 1A and 1B. In some examples, the functionalities described herein, in relation to instructions to implement functions of components of apparatus 100 and any additional instructions described herein in relation to the storage medium, may be implemented as engines or modules including any combination of hardware and programming to implement the functionalities of the modules or engines described herein. The functions of components of apparatus 100 may also be implemented by a respective processor. in examples described herein, the processor may include, for example, one processor or multiple processors included in a single device or distributed across multiple devices.

FIG, 2 is a schematic diagram of an example process 200 for predicting a hiring demand. In one example, process 200 may be implemented by resource demand prediction engine 106 of FIGS. 1A and 1B. At 202, historical recruitment data may be received from data source(s) 234 and the historical recruitment data may be pre-processed. In one example, pre-processing the historical recruitment data may include creating datasets with a plurality of recruitment parameters (e.g., at 204), cleansing the datasets (e.g., at 206), imputing the datasets (e.g., at 208), or any combination thereof.

In one example, cleansing the datasets may include detecting and replacing an outlier value of a variable in the historical recruitment data. In another example, cleansing the datasets may include normalizing a value of a variable in the historical recruitment data. Further, the datasets may be imputed for any missing data value, invalid data value, or scaling a data value in each dataset. In this example, missing or invalid data values can be processed tb impute values to replace the missing or invalid data values. In other words, the datasets may be imputed to insert estimates for missing values that may have minimal impact on the analysis method regarding the values that are not missing. The datasets may be imputed through different statistical processes such as mean, previous entry, next entry, automated method (e.g., mice in R), and the like.

Furthermore, at 210, the pre-processed datasets may be filtered based on a set of recruitment parameters, In one example, the set of recruitment parameters may be selected from the plurality of recruitment parameters. In one example, filtering the pre-processed datasets may include selecting the set of recruitment parameters that are significant by statistical correlation at 212. Further, a collinearity check may be performed to remove recruitment parameters that are colinear at 214. Furthermore, the recruitment parameters may be validated through elbow graph at 216. Thus, the pre-processed datasets associated with the selected recruitment parameters may be filtered.

At 218, a time-series machine learning model may be generated with the cleansed and imputed datasets with the selected recruitment parameters In one example, generating the time-series machine learning model may include:
Stationarizing the cleansed and imputed datasets with the selected recruitment parameters at 220.
Determining parameter values for the time-series machine learning model based on Autocorrelation Function (ACF) or Partial Autocorrelation Function (PACF) at 222. For example, an Auto Regressive and Moving Average (ARMA) model may be expressed in terms of ARMA (p, q), where p is the order of Auto Regressive (AR) and q is the order of Moving Average (MA). The two orders ‘p’ and ‘q’ can be determined based on ACF and ACF.
Dividing the cleansed and imputed datasets with the selected recruitment parameters into training data, validation data, and test data at 224. For example, the cleansed and imputed datasets may be divided into 70% of training data, 10% of validation data, and 20% of test data based on time-based distribution. In other words, first 70% entries may be provided as the training data, next 10% entries may be provided as the validation data, and last 20% entries may be provided as the test data.
Building the time-series machine learning model with the training data at 226.
Validating the time-series machine learning model with 10% validation data at 228. In one example, the time-series machine learning model may be tuned based on the validation.
Predicting the time-series machine learning model with the test data at 230 (e.g., as explained with respect to FIG, 1A).

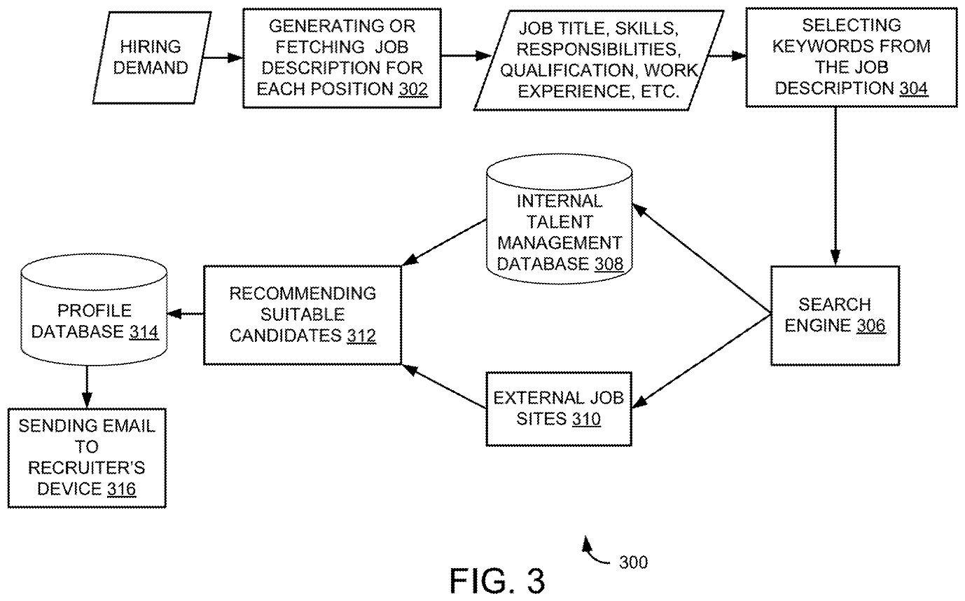

At 232, a hiring demand may be predicted for an upcoming period using the time-series machine learning model based on successful testing. The output of the time-series machine learning model may provide management, information technology (IT) support, procurement department, and accounts department an automated advanced idea about the skill, technology, and experience wise hiring counts, thereby enabling to provision cost and infrastructure resources accordingly. The output may be fed to various tools for generating the job description and for searching suitable profiles as described in FIG. 3.

FIG, 3 is a schematic diagram of an example process 300 for generating a job description based on the hiring demand and determining a suitable profile corresponding to the job description. At 302, the output (i.e., the hiring demand) generated by the time-series machine learning model may be fed as an input to NLP-based models. For each gap in proficiency, detailed job description including Job title, list of required skills, roles and responsibilities, qualification, experience, good to have, job location, and the like may be generated with the help of a job description database based on the hiring demand.

At 304, keywords may be selected from the job description and a search string may be generated using the selected keywords. In one example, the NLP-based models may be used to generate the search string using the job description. At 306, the search string may be provided to a search engine based on the detailed Job description.

At 308, using the NLP generated “search string”, internal talent management database may be accessed and suitable profiles can be retrieved. At 310, using the NLP generated “search string”, external job sites (e.g., Naukri®, LinkedIn®, and the like) may be accessed through Feedly™/web crawler and suitable profiles can be retrieved. The suitable profile may include data such as requisition id, matching profile percentage where higher the percentage denotes a best suitable candidate, actual resume (e.g., in pdf format, word format, or the like), name, contact information, notice period duration, how actively each candidate is searching job, and the like.

At 312, the suitable profiles may be recommended by the search engine. At 314, the suitable profiles may be stored in a database of the enterprise. At 316, the suitable profiles may be automatically sent to a user device, for instance, via an email, In some examples, the suitable profiles may be displayed on a display of the user device. After fulfillment, the success may be measured for each predicted hiring demand versus selected/rejected candidate count and benefits of overall prediction and search engine. The measured success may be used for further learning of the time-series machine learning model.

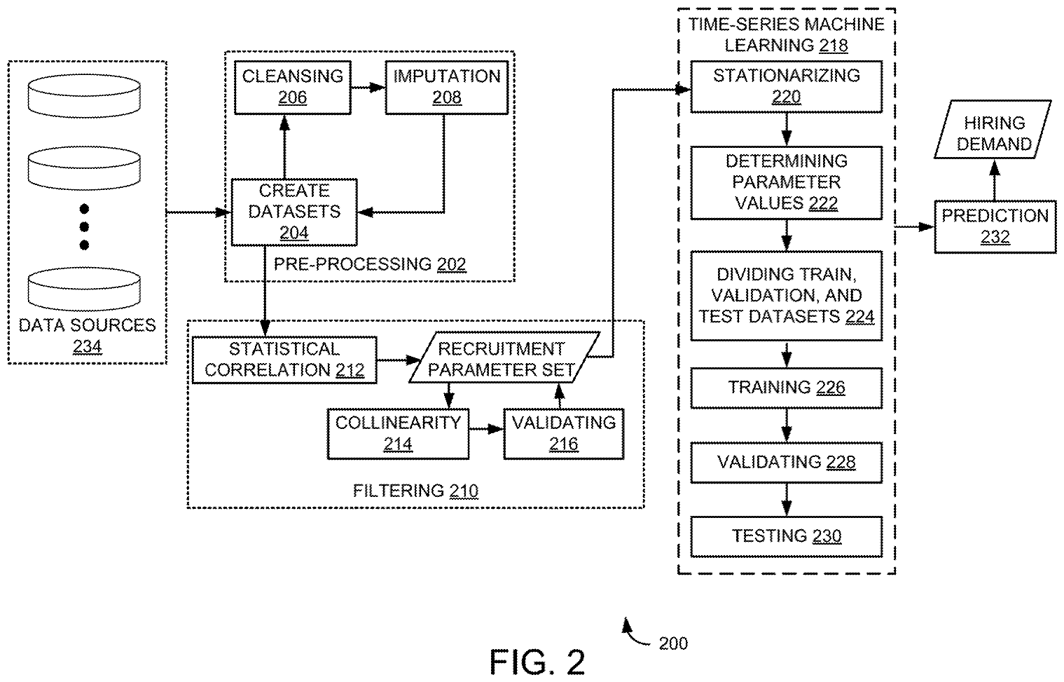

It should be understood that the processes depicted in FIGS. 2 and 3 represent generalized illustrations, and that other processes may be added, or existing processes may be removed, modified, or rearranged without departing from the scope and spirit of the present application. In addition, it should be understood that the processes may represent instructions stored on a computer-readable storage medium that, when executed, may cause a processor to respond, to perform actions, to change states, and/or to make decisions. Alternatively, the processes may represent functions and/or actions performed by functionally equivalent circuits like analog circuits, digital signal processing circuits, application specific integrated circuits (ASICs), or other hardware components associated with the system. Furthermore, the flow charts are not intended to limit the implementation of the present application, but rather the flow charts illustrate functional information to design/fabricate circuits, generate machine-readable instructions, or use a combination of hardware and machine-readable instructions to perform the illustrated processes.

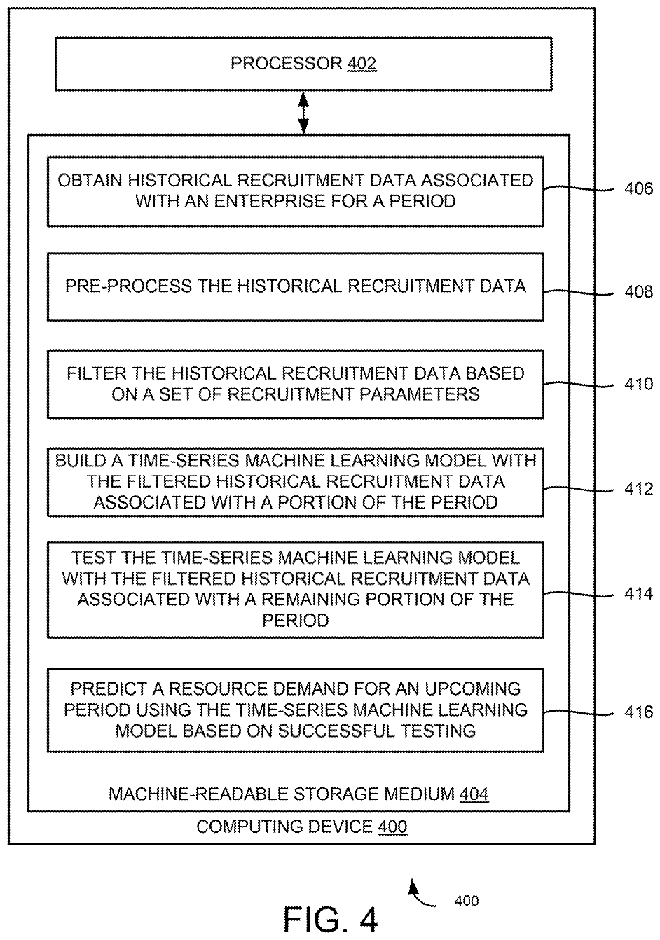

FIG. 4 is a block diagram of an example computing device 400 including a non-transitory machine-readable storage medium 404, storing instructions to predict a hiring demand using a time-series machine learning model. Computing device 400 may include a processor 402 and machine-readable storage medium 404 communicatively coupled through a system bus. Processor 402 may be any type of central processing unit (CPU), microprocessor, or processing logic that interprets and executes machine-readable instructions stored in machine-readable storage medium 404. Machine-readable storage medium 404 may be a random-access memory (RAM) or another type of dynamic storage device that may store information and machine-readable instructions that may be executed by processor 402. For example, machine-readable storage medium 404 may be synchronous DRAM (SDRAM), double data rate (DDR), rambus DRAM (RDRAM), rambus RAM, etc., or storage memory media such as a floppy disk, a hard disk, a CD-ROM, a DVD, a pen drive, and the like. In an example, machine-readable storage medium 404 may be a non-transitory machine-readable medium. In an example, machine-readable storage medium 404 may be remote but accessible to computing device 400.

As shown in FIG. 4, machine-readable storage medium 404 may store instructions 406-416. In an example, instructions 406-416 may be executed by processor 402 to predict the hiring demand of an enterprise using the time-series machine learning model. Instructions 406 may be executed by processor 402 to obtain historical recruitment data associated with an enterprise for a period.

Instructions 408 may be executed by processor 402 to pre-process the historical recruitment data. In one example, instructions to pre-process the historical recruitment data may include instructions to cleanse the historica recruitment data, impute the historical recruitment data, or a combination thereof. In other examples, instructions to pre-process the historical recruitment data may include instructions to generate a dataset associated with a plurality of recruitment parameters using the historical recruitment data and pre-process the generated dataset with the plurality of recruitment parameters. in one example, the set of recruitment parameters may be selected from the plurality of recruitment parameters. The dataset may be a time-series dataset that includes a series of values of an observable measured in successive periods of time.

Instructions 410 may be executed by processor 402 to liter the pre-processed historical recruitment data based on a set of recruitment parameters. Instructions 412 may be executed by processor 402 to build a time-series machine learning model with the filtered historical recruitment data associated with a portion of the period.

Instructions 414 may be executed by processor 402 to test the timeseries machine learning model with the filtered historical recruitment data associated with a remaining portion of the period. In one example, instructions to test the time-series machine learning model may include instructions to predict a resource demand for the remaining portion of the period using the trained timeseries machine learning model, and determine accuracy of the trained time-series machine learning model by comparing the predicted resource demand for the remaining portion of the period with the historical recruitment data associated with the remaining portion of the period. The time-series machine learning model may be used to predict the resource demand for the upcoming period when the accuracy is greater than or equal to a predefined threshold.

In some examples, n n-transitory machine-readable storage medium 404 may include instructions to retrain the trained time-series machine learning model with historical recruitment data associated with a modified period through tuning model parameters when the accuracy is less than the predefined threshold.

Instructions 416 may be executed by processor 402 to predict a resource demand for an upcoming period using the time-series machine learning model based on successful testing. In one example, instructions to predict the resource demand for the upcoming period may include instructions to retrieve real-time recruitment data associated with the enterprise, and predict the resource demand for the upcoming period in a proficiency constraint, by analyzing the real-time recruitment data using the time-series machine learning model. The proficiency constraint may include, but not limited to, a location, a technology area, role, experience, and/or the like. For example, the time-series machine learning model may predict a number of employees to be hired in a particular location, in a particular project, in a particular role, with a particular experience level, or any combination thereof.

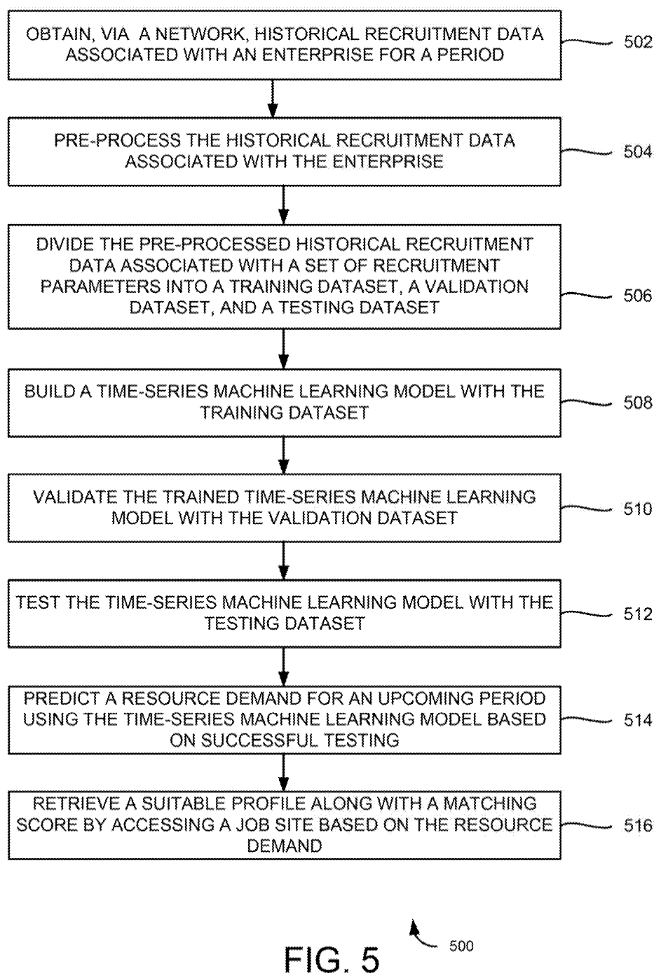

FIG. 5 is a flow diagram illustrating an example method 500 for retrieving a suitable profile along with a matching score corresponding to a gap in proficiency associated with a predicted hiring demand. It should be understood that the process depicted in FIG. 5 represents generalized illustrations, and that other processes may be added, or existing processes may be removed, modified, or rearranged without departing from the scope and spirit of the present application. In addition, it should be understood that the processes may represent instructions stored on a computer-readable storage medium that, when executed, may cause a processor to respond, to perform actions, to change states, and/or to make decisions. Alternatively, the processes may represent functions and/or actions performed by functionally equivalent circuits like analog circuits, digital signal processing circuits, application specific integrated circuits (ASICs), or other hardware components associated with the system. Furthermore, the flow charts are not intended to limit the implementation of the present application, but rather the flow charts illustrate functional information to design/fabricate circuits, generate machine-readable instructions, or use a combination of hardware and machine-readable instructions to perform the illustrated processes.

At 502, historical recruitment data associated with an enterprise for a period may be obtained via a network. At 504, the historical recruitment data associated with the enterprise may be pre-processed. At 506, the pre-processed historical recruitment data associated with a set of recruitment parameters may be divided into a training dataset, a validation dataset, and a testing dataset in a time-sequential manner with a defined proportion. In one example, the set of recruitment parameters may be selected>by applying a statistical correlation between a plurality of recruitment parameters. For example, the set of recruitment parameters may be selected from a group consisting of attrition, location change, retirement, skill upgrade, strategic investment, intern to hire conversion, contractor to hire conversion, technology area, and experience. In some examples, a file (e.g., CSV file) may be generated with values/relevant data points against each of the of the plurality of recruitment parameters. Further, the file can be updated with latest data points each time to improve the resource demand forecasting during the next run.

In one example, a parameter value for the time-series machine learning model may be determined based on Autocorrelation Function (ACF) or Partial Autocorrelation Function (PACE) to make the pre-processed historical recruitment data stationary. At 508, a time-series machine learning model may be built with the training dataset, for instance, upon making the pre-processed historical recruitment data stationary. At 510, the trained time-series machine learning model may be validated with the validation dataset. At 512, the time-series machine learning model may be tested with the testing dataset. At 514, a resource demand for an upcoming period may be predicted using the time-series machine learning model based on successful testing. In one example, the resource demand for the upcoming period may be predicted by predicting the resource demand for the upcoming period based on replacement and strategic constraints.

At 516, a suitable profile along with a matching score may be retrieved by accessing a job site based on the resource demand. In one example, retrieving the suitable profile along with the matching score may include:
inputting the resource demand for the upcoming period into a natural' language processing (NLP) based model,
generating, by the NLP based model, a job description corresponding to a gap in proficiencies of an employed workforce using a job description database and the resource demand,
generating a search string using the job description by the NLP model,
retrieving the suitable profile along with the matching score corresponding to the job description via inputting the search string to a search engine, and
transmitting, via the network, the suitable profile along with the matching score to a user device.

It may be noted that the above-described examples of the present solution are for the purpose of illustration only. Although the solution has been described in conjunction with a specific implementation thereof, numerous modifications may be possible without materially departing from the teachings and advantages of the subject matter described herein. Other substitutions, modifications and changes may be made without departing from the spirit of the present solution. All of the features disclosed in this specification (including any accompanying claims, abstract, and drawings), and/or all of the steps of any method or process so disclosed, may be combined in any combination, except combinations where at least some of such features and/or steps are mutually exclusive.

The terms “include,” “have,” and variations thereof, as used herein, have the same meaning as the term “comprise” or appropriate variation thereof. Furthermore, the term “based on”, as used herein, means “based at least in part on.” Thus, a feature that is described as based on some stimulus can be based on the stimulus or a combination of stimuli including the stimulus.

The present description has been shown and described with reference to the foregoing examples. It is understood, however, that other forms, details, and examples can be made without departing from the spirit and scope of the present subject matter that is defined in the following claims.

What is claimed is:

1. A non-transitory machine-readable storage medium encoded with instructions that, when executed by a processor, cause the processor to:
obtain historical recruitment data associated with an enterprise for a period;
pre-process the historical recruitment data;
filter the pre-processed historical recruitment data based on a set of recruitment parameters;
build a time-series machine learning model with the filtered historical recruitment data associated with a portion of the period;
test the time-series machine learning model with the filtered historical recruitment data associated with a remaining portion of the period; and
predict a resource demand for an upcoming period using the time-series machine learning model based on successful testing.

2. The non-transitory machine-readable storage medium of claim 1, wherein instructions to predict the resource demand for the upcoming period comprise instructions to:
retrieve real-time recruitment data associated with the enterprise; and
predict the resource demand for the upcoming period in a proficiency constraint, by analyzing the real-time recruitment data using the time-series machine learning model, wherein the proficiency constraint is selected from a group consisting of a location, a technology area, role, and experience.

3. The non-transitory machine-readable storage medium of claim 1, wherein instructions to test the time-series machine learning model comprise instructions to:
predict a resource demand for the remaining portion of the period using the trained time-series machine learning model; and
determine accuracy of the trained time-series machine learning model by comparing the predicted resource demand for the remaining portion of the period with the historical recruitment data associated with the remaining portion of the period, wherein the time-series machine learning model is used to predict the resource demand for the upcoming period when the accuracy is greater than or equal to a predefined threshold.

4. The non-transitory machine-readable storage medium of claim 3, further comprising instructions to:
retrain the trained time-series machine learning model with historical recruitment data associated with a modified period through tuning model parameters when the accuracy is less than the predefined threshold.

5. The non-transitory machine-readable storage medium of claim 1, wherein instructions to pre-process the historical recruitment data comprise instructions to cleanse the historical recruitment data, impute the historical recruitment data; or a combination thereof.

6. The non-transitory machine-readable storage medium of claim 1, wherein instructions to pre-process the historical recruitment data comprise instructions to:
generate a dataset associated with a plurality of recruitment parameters using the historical recruitment data, wherein the dataset is a time-series dataset that includes a series of values of an observable measured in successive periods of time, wherein the set of recruitment parameters is selected from the plurality of recruitment parameters; and
pre-process the generated dataset with the plurality of recruitment parameters.

7. An apparatus comprising:
a processor: and
a memory coupled to the processor, wherein the memory comprises a resource demand prediction engine to:
obtain historical recruitment data associated, with an enterprise for a period, wherein the historical recruitment data is a time-series data;
cleanse and impute the historical recruitment data;
divide the historical recruitment data associated with a set of recruitment parameters in time-sequential order into a training dataset, a validation dataset, and a testing dataset upon cleansing and imputing;
train a time-series machine learning model with the training dataset;
validate the trained time-series machine learning model with the validation dataset;
test the time-series machine learning model with the testing dataset; and
predict a resource demand for an upcoming period using the timeseries machine learning model based on successful testing.

8. The apparatus of claim 7, wherein the memory further comprises a profile matching engine, to:
input the resource demand for the upcoming period into a natural language processing (NLP) based model to:
generate a job description corresponding to a gap in proficiencies of an employed workforce using a job description database and the resource demand; and
generate a search string using the job description;
input the search string to a search engine to determine a suitable profile along with a matching score corresponding to the job description by accessing a job site; and
transmit the suitable profile along with the matching score to a user device,

9. The apparatus of claim 7, wherein the resource demand prediction engine is to:
predict the resource demand for the upcoming period based on at least one of replacement and strategic constraints in proficiency constraint, wherein the proficiency constraint is selected from a group consisting of different technology areas, roles, and experiences,

10. The apparatus of claim 7, wherein the resource demand prediction engine is to:
manage infrastructure resources for a number of employees corresponding to the predicted resource demand.

11. A method comprising:
obtaining, via a network, historical recruitment data associated with an enterprise for a period;
pre-processing the historical recruitment data associated With the enterprise;
dividing the pre-processed historical recruitment data associated with a set of recruitment parameters into a training dataset, a validation dataset, and a testing dataset in a time-sequential manner with a defined proportion;
building a time-series machine learning model with the training dataset;
validating the trained time-series machine learning model with the validation dataset;
testing the time-series machine learning model with the testing dataset;
predicting a resource demand for an upcoming period using the time-series machine learning model based on successful testing; and
retrieving a suitable profile along with a matching score by accessing a job site based on the resource demand.

12. The method of claim 11, wherein predicting the resource demand for the upcoming period comprises:
predicting the resource demand for the upcoming period based on replacement and strategic constraints.

13. The method of claim 11, wherein the set of recruitment parameters are selected by applying a statistical correlation between a plurality of recruitment parameters, and wherein the set of recruitment parameters are selected from a group consisting of attrition, location change, retirement, skill upgrade, strategic investment, intern to hire conversion, contractor to hire conversion, technology area, and experience.

14. The method of claim 11, further comprising:
determining a parameter value for the time-series machine learning model based on Autocorrelation Function (ACF) or Partial Autocorrelation Function (PACF) prior to training the time-series machine learning model to make the pre-processed historical recruitment data stationary.

15. The method of claim 11, wherein retrieving the suitable profile along with the snatching score comprises:
inputting the resource demand for the upcoming period into a natural language processing (NLP) based model;
generating, by the NLP based model, a job description corresponding to a gap in proficiencies of an employed workforce using a job description database and the resource demand;
generating a search string using the job description by the NLP model;
retrieving the suitable profile along with the matching score corresponding to the job description via inputting the search string to a search engine; and
transmitting, via the network, the suitable profile along with the matching score to a user device.
